(19) United States
(12) Patent Application Publication
(10) Pub. No.: US 2006/0257628 A1
(43) Pub. Date: Nov. 16, 2006

(54) Watermarked polymeric sheet

(76) Inventor: Jonathan James Cooper, Colchester (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/490,610

(22) Filed: Jul. 21, 2006

Related U.S. Application Data
(62) Division of application No. 10/943,733, filed on Sep. 17, 2004.

(30) Foreign Application Priority Data
Sep. 18, 2003 (GB) GB 0321822.9

(51) Int. Cl. B32B 3/00

(52) U.S. Cl. 428/156

(57) ABSTRACT

A watermarked polymeric sheet including a stretched sheet of a polymeric material having a plurality of indentations in at least one of its surfaces, the indentations including areas of increased translucency, which form a watermark that is visible by transmitted light.

### RELATED APPLICATIONS

This application is a divisional of application Ser. No. 10/943,733, filed Sep. 17, 2004, which claims priority to GB 0321822.9, filed Sep. 18, 2003. The contents of these applications are incorporated herein by reference in their entireties.

### BACKGROUND OF THE INVENTION

1. Field of the Invention

The present invention relates to a watermarked polymeric sheet and a method of making the same. In particular, but not exclusively, the invention relates to a watermarked synthetic paper and a method of making a watermarked synthetic paper.

2. Description of the Related Art

In this specification, the term “watermark” means a mark formed from areas of increased and/or decreased translucency that is visible by transmitted light and resembles a conventional watermark in a sheet of cellulose-based paper. The terms “watermarked” and “watermarking” should be construed accordingly.

The term “synthetic paper” is used herein and throughout the specification to mean plastics film and sheet products having a feel and printability similar to cellulose paper. It has been recognized that plastics sheet of these types can provide an improved alternative to paper where durability and toughness are required. Plastics sheets produced from polyolefins have several advantages over other plastics since they offer UV resistance, good tear strength and the ability to be recycled in many post-consumer waste applications.

Synthetic papers have been produced commercially by the plastics industry for many years and have taken a number of different forms. They have included products having voided (i.e. multicellular) or unvoided structures, some of which have been coated with filler- and/or pigment-containing surface coatings to improve printing qualities. The voiding technique has frequently been used to reduce the density of the synthetic paper produced. A voiding agent such as zinc-calcium resinate is generally used, which causes voiding when a heated sheet of synthetic paper is stretched. This technique produces a very serviceable sheet that has gained widespread commercial acceptance.

Watermarking may be useful as a security feature, to make copying more difficult and so prevent forgery. This may be valuable for items such as banknotes, checks, share certificates and identity cards, and labels for high value products such as wine, perfume and pharmaceuticals. Watermarking may also be useful for decorative purposes.

A process for making a watermarked synthetic paper product is described in EP 0655316. In that process, a synthetic paper product is made in a conventional manner by extruding a film of high density polyethylene and then stretching the film in the machine direction and the transverse direction to produce biaxial orientation of the polymer molecules. Prior to stretching, the film is passed between a pair of rollers, one of which has a patterned surface in relief or of hollows, to produce an impression on the surface of the film. This produces a corresponding pattern of light and dark areas in the film after stretching, which can be seen by transmitted light. It has been shown that the dark areas, which correspond to the in relief portions of the roller, are caused by an increase in substance in those areas, and vice versa for the light areas of the film.

Although the process described in EP 0655316 may be used to make a watermarked product, we have found that the watermark is rather indistinct and not well defined. The pattern also generally has a short repeat length, depending on the circumference of the patterned roller, and it must therefore be relatively simple. If a different watermark or pattern is required, the roller must be changed, which is a complex and time-consuming process. Another disadvantage is that the watermark cannot include variable information or data, such as an identification code, date or serial number.

It is an object of the present invention to provide a watermarked polymeric sheet and a method of making a watermarked polymeric sheet that mitigates at least some of the aforesaid disadvantages.

### SUMMARY OF THE INVENTION

According to the present invention there is provided a method of making a watermarked polymeric sheet, the method including forming a web of a polymeric material, selectively irradiating portions of the web with electromagnetic radiation, and stretching the web to form a stretched sheet having areas of increased translucency that correspond to the irradiated portions of the web, the areas of increased translucency forming a watermark that is visible by transmitted light.

The watermarked polymeric sheet has a plurality of indentations in areas corresponding to the irradiated portions of the web. The indentations comprise the areas of increased translucency that form the watermark.

We have found that watermarks produced according to the present invention are distinct and well defined. The pattern may have any repeat length and can be simple or complex. Different watermarks can be generated very easily without having to alter or reconfigure the apparatus, simply by controlling the light source. The watermark may be adapted readily to include logos, pictures, text and variable information such as identification codes, dates and serial numbers.

The polymeric material may include at least one polyolefin, which is preferably polyethylene.

Advantageously, a plurality of voids are formed in the stretched sheet. The polymeric material may include a voiding agent to help promote the formation of voids.

Advantageously, at least two polymeric materials are co-extruded to form a multi-layer web having a base layer and at least one outer layer. The polymeric materials may include a first material containing a voiding agent that forms the base layer and a second material containing substantially no voiding agent that forms the outer layer.

The energy of the radiation incident on the irradiated portions of the web radiation may be in the range 0.04-4 J/mm2, preferably 0.1-1.6 J/mm2, more preferably 0.2-0.8 J/mm2.

The irradiating radiation may be concentrated onto a spot on the web surface with an area in the range 0.05-5mm2, preferably 0.1-2.5mm2, more preferably 0.25-1 mm2. To achieve this spot size, the radiation may be focused, or a narrow beam of radiation may be used, or a small light source may located in close proximity to the plane of the web. Preferably, the web is irradiated using a laser.

The incident radiation may be scanned and/or pulsed to create a pattern of irradiation on the surface of the web. The scanning and/or pulsing may be controlled, for example by a computer, to produce different patterns, images, logos or text.

Advantageously, the web is irradiated after it has been conditioned and before the stretching operation has been completed. By “conditioned” we mean an operation whereby the temperature of the web is stabilized and made uniform across its width. Preferably, the web is irradiated substantially at the start of the stretching operation.

Advantageously, the web is stretched by a ratio of between 1:2 and 1:10, preferably approximately 1:4. The web may be stretched biaxially, and preferably simultaneously.

The polymeric sheet is preferably a synthetic paper.

The surface of the polymeric sheet may be treated chemically and/or by corona discharge for improved print acceptance.

Advantageously, the polymeric material includes a copolymer of HDPE, a rosin derived voiding agent, polystyrene, HDPE homopolymer, calcium carbonate filler, titanium dioxide, styrene butadiene and calcium oxide.

According to another aspect of the invention there is provided a watermarked polymeric sheet, comprising a stretched sheet of a polymeric material having a plurality of indentations in at least one surface thereof, the indentations comprising areas of increased translucency, which form a watermark that is visible by transmitted light.

The weight per unit area of the polymeric sheet may be reduced in the indentations. The indentations may have an average depth in the range 4-100 μm, preferably 10-40 μm.

The polymeric material may include at least one polyolefin, which is preferably polyethylene. The stretched sheet may include a plurality of voids and the polymeric material may include a voiding agent. The number of voids may be reduced in the indentations.

Preferably, the stretched sheet has multiple co-extruded layers, including a base layer and at least one co-extruded outer layer. Advantageously, the base layer includes a plurality of voids and at least one co-extruded outer layer includes substantially no voids.

The sheet is preferably biaxially oriented. The polymeric sheet may be a synthetic paper. Advantageously, the surface of the polymeric sheet includes a coating and/or is treated chemically and/or by corona discharge.

The polymeric sheet is suitably a synthetic paper that comprises at least one printable surface layer and a base layer (which can also be termed the core layer if there is more than one surface layer e.g. one on either side of the base layer). The synthetic paper may be formed either:
A. by single extrusion of a single composition in which the surfaces and the core portion of the single extrudate represent the surface and base layers respectively, or
B. by co-extrusion of the composite from two or more compositions where the relatively thicker of the two layers forms the base layer and the relatively thinner of the two layers represents the surface layer, or
C. by lamination of a plurality of layers whereby at least one of the outermost layers represents the surface layers and the layer(s) below said surface layer or in between the two outer surface layers represents the base layer, or
D. by applying a coating of a printable layer on the surface layer of a sheet produced by any of the methods (A) to (C) above.

Sheet produced by co-extrusion and having the coating of a printable layer on the surface thereof is preferred. Methods of lamination and co-extrusion are well known in the art. Descriptions of formulations comprising a polyolefin and methods for producing synthetic papers based on polyolefins can be found in GB-A-1470372, GB-A-1492771 and GB-A-1490512. Further, a description of particularly advantageous coatings can be found in GB-A-2177413. The disclosures of all the aforementioned specifications are included herein by reference.

A voiding agent can be used both in the surface layer and in the base layer but is particularly effective in the base layer.

Fillers may be used in films/sheets such as synthetic paper intended for printing to provide an appropriate opaque white surface. These fillers are usually selected from inert minerals such as chalk, silica or clay. In addition, minor additives may be used to render the film/sheet anti-static and/or to lower its density.

It is well recognized that polyolefin films have low surface energies and this generally means that printing is difficult because the ink does not readily wet the surface and the dried ink does not adhere sufficiently to the surface thereof. In order to overcome these problems, the surface of polyolefin films/sheet may be subjected to various treatments such as e.g. a corona discharge treatment. Such treatments improve ink laydown and adhesion sufficiently to provide a useful material. The material so treated may, in some cases, lack absorption and require specialized printing techniques.

The lack of absorption of films/sheets such as synthetic paper can be overcome by applying a coating comprising a major amount of a absorbent filler and a minor amount of an adhesive binder. The coating can be incorporated during the manufacturing process. Such a method yields a product that is receptive to print and such products have gained wide commercial acceptance. Where such coatings are inconvenient and expensive to apply and require a separate manufacturing process, or render the surface so treated susceptible to the adverse effects of water and solvents, a higher amount of a filler such as silica can be employed.

The base layer in the film or sheet of the synthetic paper may also include other components such as pigments, other fillers, rubbers and the like. Thus, the base layer may be of any composition such as are described in GB-A-1470372 and GB-A-1492771. In a preferred embodiment, the composition of the base layer is as follows:

| Component | Parts by weight |
|---|---|
| High density polyethylene (copolymer) | 100 |
| Calcium-zinc resinate | 5-15 |
| Polystyrene | 4.5-5.5 |
| High density polyethylene (homopolymer) | 17.5-21 |
| Calcium carbonate filler | 15-25 |
| Titanium dioxide | 5-10 |
| Styrene-butadiene copolymer | 0-1.0 |
| Calcium oxide | 0.4-1.0 |

### BRIEF DESCRIPTION OF THE DRAWINGS

Embodiments of the invention will now be described by way of example, with reference to the accompanying drawings, in which:

FIG. 1 is a schematic sectional side view of an apparatus for manufacturing a watermarked product;

FIG. 2 is a schematic plan view of a web passing through a stretching machine in the apparatus shown in FIG. 1;

FIG. 3 is an image of a first watermarked product, viewed by transmitted light;

FIG. 4 is a magnified image of the first watermarked product, viewed by reflected light;

FIG. 5 is a magnified image of the first watermarked product, viewed by transmitted light;

FIG. 6 is a graphical representation of the profile of the first watermark pattern;

FIG. 7 is an image of a second watermarked product, viewed by transmitted light;

FIGS. 8 and 9 are magnified images of the second watermarked product, viewed by reflected and transmitted light respectively;

FIG. 10 is a plan view showing part of a modified apparatus for manufacturing a watermarked product, and

FIG. 11 is a magnified image of a third watermarked product, viewed by transmitted light.

### DETAILED DESCRIPTION OF THE PREFERRED EMBODIMENT

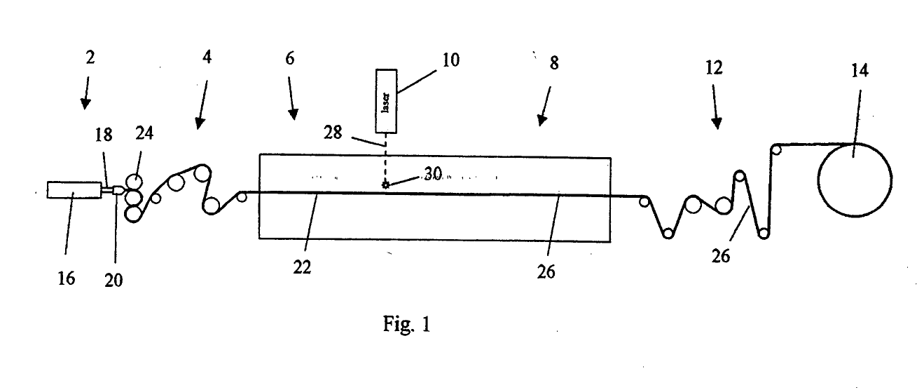

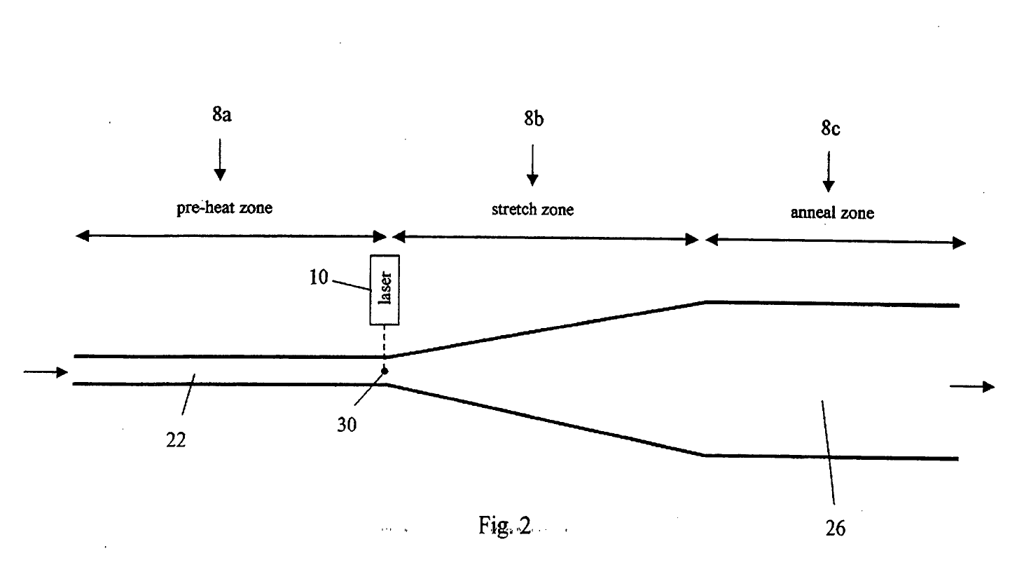

An apparatus for making watermarked synthetic paper is shown in FIGS. 1 and 2. The apparatus includes an extrusion apparatus 2, a first set of conditioning rollers 4, a simultaneous biaxial stretching machine 6 that is mounted in an oven 8, a light source 10, a second set of conditioning rollers 12 and a take up reel 14.

The extrusion apparatus 2 may for example be a conventional three-layer co-extrusion apparatus comprising first and second extruders (only the first extruder 16 being shown), a distributor 18 and a sheeting die 20. The co-extrusion apparatus enables a three-layer co-extruded polymeric extrudate comprising a core layer and two surface layers to be produced continuously.

The first conditioning rollers 4 are mounted immediately downstream of the extrusion die 20. The polymeric material is extruded into the nip between a first pair of cooled rollers 24, which cool and solidify the extrudate 22 to form a web 22. The web 22 then passes around the other conditioning rollers 4, which condition the web prior to delivering it to the stretching machine 6, to ensure that the temperature of the web is stable and uniform across its width.

The stretching machine 6 stretches the conditioned web biaxially: i.e. in the longitudinal or machine direction (MD) and the transverse direction (TD). The web 22 is thus converted into a stretched sheet 26. The stretching machine 6, which is not shown in detail, may be of a conventional type, for example as described in GB 1442113, the content of which is incorporated by reference herein. Briefly, the stretching machine 6 includes two endless articulated chains that are driven along predetermined paths, the links of the chains being caused to expand and contract as the chains rotate. A series of gripping devices attached to the chain links successively engage the edges of the web 22 as it enters the stretching machine 6 and move apart from one another in the longitudinal and transverse directions as the web advances, thereby stretching the web 22 simultaneously in both directions. After completing the stretching operation, the gripping devices release the stretched sheet 26 and rotate back to the start of the stretching machine. The stretching machine 6 is mounted in a circulating air oven 8, which is used to control the temperature of the web throughout the stretching process.

The stretching operation consists of three distinct stages, the oven 8 being divided into three zones to maintain the web 22 and the stretched sheet 26 at the correct temperatures during each of those stages. In the first stage, the clamped web 22 is heated to the correct temperature for stretching in the first (pre-heat) zone 8a of the oven. The web 22 is not stretched during this first stage but it is clamped by the gripping devices to maintain it in a flat condition. The pre-heated web 22 is then stretched as it passes through the second (stretch) zone 8b of the oven, which controls the temperature of the web during the stretching operation. Finally, in the third stage of the stretching operation, the stretched sheet 26 is annealed by being held in the stretched condition as it passes through the third (annealing) zone 8c of the oven, before being released by the gripping devices.

Downstream of the stretching machine 6, the second set of conditioning rollers 12 is provided to condition the stretched sheet 26 as it emerges from the oven 8. The conditioned sheet is then wound onto the take-up reel 14. Optionally, the apparatus may include an air blower for cooling the sheet and edge trimmers for removing waste material from the side edges of the sheet. A corona discharge machine may also be provided for treating the surface of the sheet 26 to make it more receptive to print.

A light source 10 is mounted above the stretching machine 6 and arranged to direct a beam of radiation 28 through a window in the oven 8 onto the web 22. The beam of radiation 28 is focused onto a spot 30 on the surface of the web 22 approximately at the point where stretching of the web commences: i.e. at the transition from the pre-heat zone 8a to the stretching zone 8b of the oven. The light source 10 is preferably a medium or high power laser, for example a CO2 laser with an output power of 50 W to 2 kW.

In use, a polymeric substance, for example polyethylene or polypropylene, is extruded through the die 20 to form a layer of extrudate, typically with a width of about 400 mm and a thickness of 5 mm. The extrudate may have a layered composition, consisting of a base layer and two co-extruded outer layers. In a preferred embodiment, the base layer and the outer layers are both made primarily of polyethylene, the base layer (but not the outer layers) also including a voiding agent.

Immediately after leaving the extrusion die, the extrudate passes between the cooled rollers 24, which cool and solidify the extrudate to form the web 22, which typically has a thickness of about 1.5 mm. In the case of a layered web, the base layer typically a thickness of 1.32 mm and the two outer layers are each about 0.9 mm, thick. The web 22 then passes around the other conditioning rollers 4 to prepare it for stretching.

The conditioned web 22 is delivered to the stretching machine 6, where it is stretched as described above to form a stretched sheet 26. The stretching ratios in the longitudinal and transverse directions may be different but usually they are similar. Generally, the dimensions of the web are increased in both directions by a ratio of between 1:2 and 1:10, a ratio of 1:4 being typical. The overall thickness of the sheet is at the same time reduced, typically to approximately 100 μm. The stretching operation produces biaxial orientation of the polymer molecules and causes microscopic voids to be formed in the base layer of the sheet. This reduces the density of the sheet and increases its rigidity, making it suitable for use as a synthetic paper.

The laser 10 is mounted to irradiate the web approximately at the point where the stretching process begins: i.e. at the transition between the first and second zones of the oven. The surface of the web is heated by the laser beam, producing a small localized increase in temperature (for example of about 2° C.). This results in differential stretching of the web, the slightly warmer irradiated regions stretching more readily than the remainder of the web.

After the leaving the stretching machine, the stretched sheet passes around the second set of conditioning rollers 12 and is then wound onto the take-up reel 14. Optionally, the sheet may be cooled by an air blower and waste material may be removed from the side edges of the sheet by edge trimmers. The surface of the sheet may be treated with a corona discharge machine.

The sheet may subsequently be coated to increase its ability to be printed. Many coating substances commonly used in the paper industry may be used, including aqueous coatings, latex-based coatings and in particular coatings of the type described in GB-A-2177413, the content of which is incorporated by reference herein. It may then be printed. An adhesive coating such as a pressure-sensitive or heat-sensitive coating may alternatively or additionally be applied to one of the sheet surfaces, allowing it to be converted into self-adhesive labels or tags.

The finished sheet carries markings that are visible by transmitted light in regions of the sheet corresponding to the areas of the web that were irradiated by the laser prior to stretching. These markings consist of shallow indentations in the surface of the sheet. The amount of material per unit area is less in the indentations than in the rest of the sheet and, in addition, less voiding of the base layer is found in the indentations. We believe that these effects both result from the increased temperature caused by the incident radiation, which allows the web to stretch more readily. Both of these factors affect the translucency of the sheet, the translucency being greater in the irradiated regions where the sheet is thinner and has fewer voids. The process of irradiation followed by stretching therefore produces a watermark that is visible by transmitted light.

The laser may be pulsed or continuous and may be either fixed or moveable, allowing it to irradiate different parts of the web as the web passes through the stretching machine. Alternatively, scanning equipment may be provided to direct the laser beam onto different parts of the web.

By pulsing the laser it is possible to produce a watermark comprising a line of dots running along the length of the sheet, the distance between the dots being dependent on the pulse frequency of the laser and the line speed of the machine. If the point at which the laser beam hits the web is moved during operation, a different pattern may be produced: for example, by moving the point back and forth in the transverse direction an oscillating wave or snake-like pattern can be produced. A more complicated pattern or image can be produced by pulsing the laser beam and scanning it across the width of the sheet to build up a pattern or image, in a manner similar to that employed in a laser printer. The scanning equipment can be digitally controlled, for example by a computer, allowing a variety of images to be generated and/or allowing variable information such as a serial number or date to be incorporated into the watermark.

Examples of some watermarked products and the processes used to make those products are provided below.

### EXAMPLE 1

The following composition was used to produce Compound A (used in the production of the base material):

| | Parts by |
|---|---|
| Component | Wt |
| Rigidex TM 002/55 HDPE copolymer (MFI 0.2 g/10 min | 100 |
| & density 0.955 Kg/m³, ex BP Chemicals Ltd) | |
| Rigidex TM HD6070EA HDPE (MFI 7.5 g/10 min & | 17.6 |
| density 0.96 Kg/m³, ex BP Chemicals Ltd) | |
| Polystyrene Grade HF888 (ex BP Chemicals Ltd) | 4.8 |
| DERTOLINE TM MP 170 | 6.0 |
| Cariflex TM TR1102 Styrene-butadiene-styrene copolymer | 0.6 |
| (ex Shell UK Ltd) | |
| Anhyd.CaCO3 (2.5 μ particle size, OMYA ex Craxton & Garry) | 21.0 |
| TiO2 (Rutile) RCR2 (ex Tioxide) | 5.8 |
| Armostat TM 400 (antistat, ex Akzo Chemicals Ltd) | 0.14 |
| Armostat TM 375D (antistat, ex Akzo Chemicals Ltd) | 0.35 |
| Caloxal TM CPA (CaO, ex Sturge Lifford Ltd) | 0.58 |
| Calcium Stearate (ex RTZ Chemicals Ltd) | 0.04 |
| Irganox TM 8215 (antiox., ex Ciba-Geigy Ind Ltd) | 0.29 |

HDPE = High density polyethylene
MFI = Melt flow index

Compound A was prepared from the above components as follows: Separate, melt blended, cooled and diced masterbatches (A1 and B) were obtained from the above with the calcium carbonate and titanium dioxide respectively and comprised:

| A1 | B |
|---|---|
| Calcium carbonate 60% w/w | Titanium dioxide 60% w/w |
| Rigidex TM HD6070EA 39.6% w/w | Rigidex TM HD6070EA 39.6% |
| | w/w |
| Armostat TM 400 0.4% w/w | Calcium Stearate 0.4% w/w |

Masterbatches A1 and B were then intermixed in appropriate proportions with the remainder of the ingredients of the composition and fed to a compounding extruder. The composition was melt blended at approximately 200° C., extruded, cooled and diced to form Compound A.

Compound A was fed to an in-line extruder of a twin extruder-distributor-sheeting die co-extrusion arrangement and Compound B was mixed at 20% with Rigidex™ HD 002/55 HDPE and fed to a secondary extruder. The sheeting die and distributor were of conventional type enabling a three-layer co-extrudate to be produced continuously comprising a layer of Compound B on each side of a layer of Compound A.

The extruders were arranged to enable each to form and feed a substantially homogeneous melt into the distributor, which was maintained at a temperature of 210° C. The die lips were adjusted to approximately 5 mm and the flow of each of the melts was adjusted to give a composite layered extrudate about 395 mm wide at an extrusion rate of 360 kg/hr.

The composite extrudate was then fed directly onto and around a set of cooling and conditioning rollers running at a peripheral speed whereby the core material was brought to a temperature of approximately 122° C. and the outer layers each to a temperature of approximately 118° C. This resulted in a conditioned composite web having an overall thickness of 1.5 mm, comprising a core thickness of 1.32 mm and two outer layers each about 0.09 mm thick.

The conditioned composite web was then fed into a simultaneous biaxial stretching machine arranged to provide a 4:1 stretch in each of the longitudinal or machine direction (MD) and the transverse direction (TD).

The stretching apparatus was provided with a three zone circulating air oven, the zones comprising preheat Zone 1, stretching Zone 2 and annealing Zone 3. The temperatures and lengths of the respective zones and the sheet speed are tabulated below:

| | Temperature | | Speed in | Speed out |
|---|---|---|---|---|
| Zones | (° C.) | Length (metres) | (metres/min) | (metres/min) |
| Zone 1 | 120 | 1 | 10.4 | — |
| Zone 2 | 120 | 1.5 | — | 43.8 |
| Zone 3 | 140 | 2 | — | 43.8 |

The web gripping devices were initially at a pitch of about 38 mm and were heated to approximately 100° C. prior to contacting the web.

The web was irradiated with a 50 W CO2 laser, arranged perpendicular to the web and focused to produce a spot with a diameter of 0.8 mm on the surface of the web, approximately at the transition between the first and second zones of the oven (i.e.just prior to stretching). The laser was pulsed at a frequency of 160 Hz, with an on time of 3.75 ms and an off time of 2.5 ms. Each pulse therefore had an energy of about 0.2 J and produced an energy density on the surface of the web of about 0.4 J/mm2, which raised the temperature of the irradiated portion of the web by about 2° C.

The composite plastics sheet thus produced had an average thickness of 0.094 mm and nominal substance of 75 gsm. This sheet was cooled, edge trimmed and then reeled.

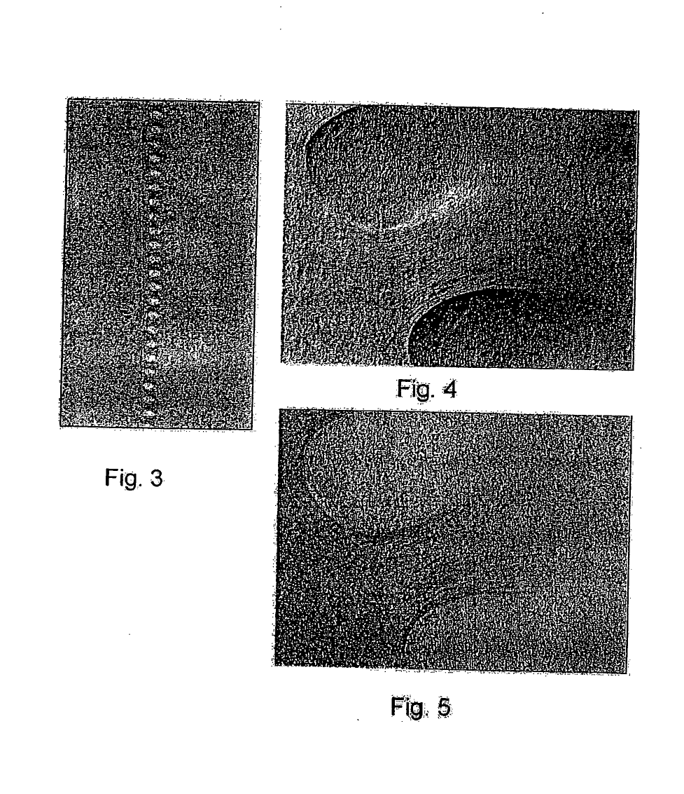

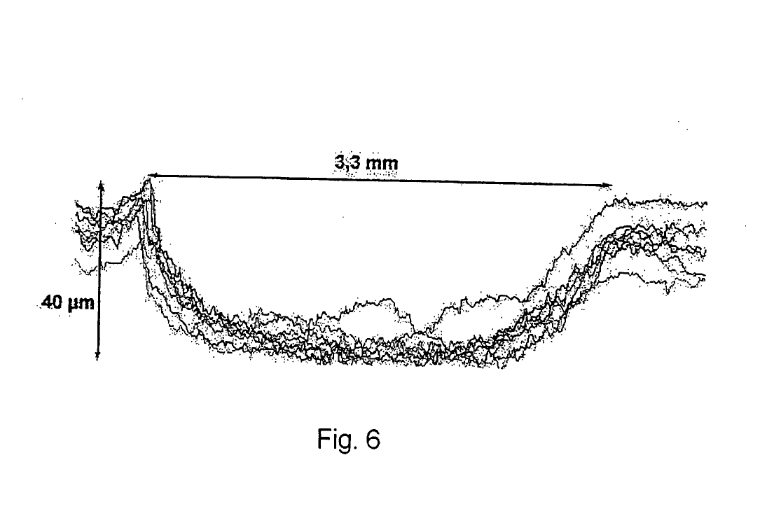

The watermark produced by the above method is shown in FIGS. 3, 4 and 5. As can be seen in FIG. 3, the watermark consists of a line of dots running in the machine direction, the dots having a greater translucency than the surrounding areas of the sheet. Each dot consists of an oval indentation in the surface of the sheet, having a width of about 3.3 mm and an average depth of about 24 μm. The profiles of a number of the indentations are shown in FIG. 6: it can be seen that the profiles are of a fairly consistent width and depth. Magnified views of the indentations are provided in FIGS. 4 (by reflected light) and 5 (by transmitted light).

### EXAMPLE 2

A composite co-extruded sheet was made using the same process and with the same composition as in Example 1. In this case, however, the laser was pulsed at a frequency of 500 Hz, with an on time of 1.6 ms and an off time of 0.4 ms. The angle of the laser was adjusted during operation, to cause lateral movement of the dot over the surface of the web (in the transverse direction).

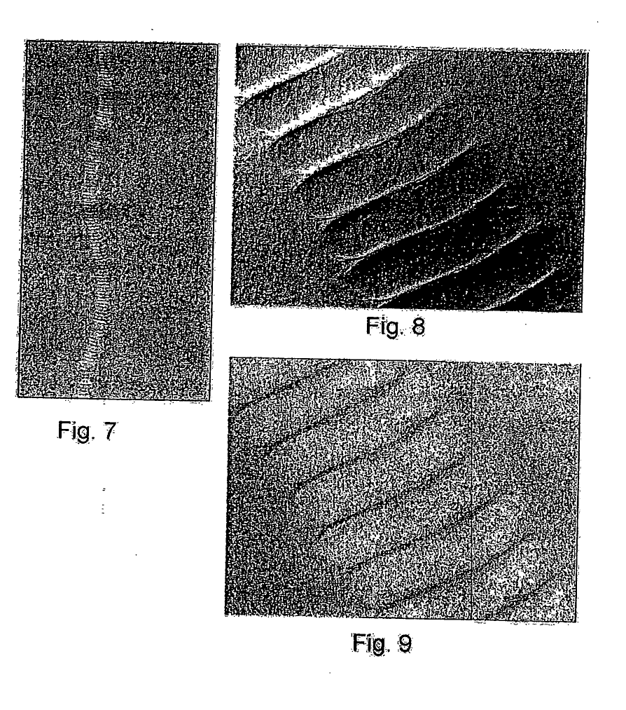

The watermark produced by this process is shown in FIGS. 7, 8 and 9. As can be seen in FIG. 7, the watermark consists of a wavy line of dots running in the machine direction. The dots are closer together than in Example 1 and consist of elongate indentations in the surface of the web, having a width of about 3 mm and an average depth of about 18 μm. Magnified views of the indentations are provided in FIGS. 8 (by reflected light) and 9 (by transmitted light).

### EXAMPLE 3

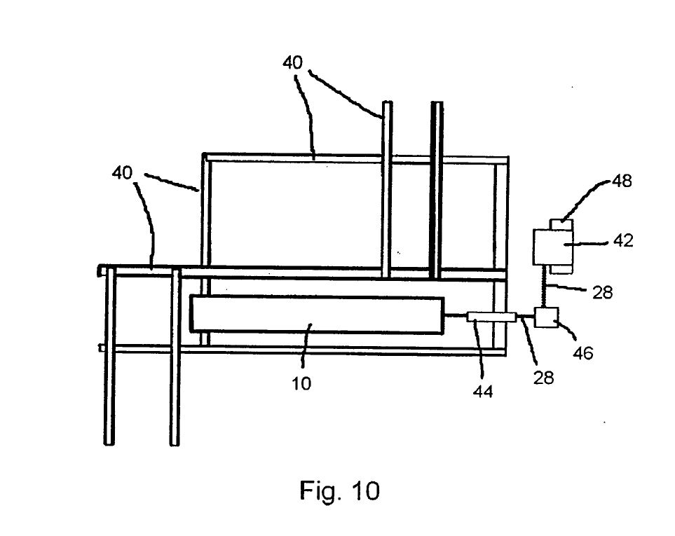

A composite co-extruded sheet was made using the same process and with the same composition as in Example 1. In this case, however, the laser 10 was mounted on a frame 40 above the oven and the laser beam 28 was directed onto the web using a scanner unit 42. The layout of the optical components was as shown in FIG. 10.

The laser 10 was mounted so that the laser beam 28 emerged in a direction parallel to the longitudinal axis of the oven. The beam was passed through a beam expander 44 and then reflected through 90° by a mirror 46 into the scanner unit 42, which was mounted above an access window 48 in the top wall of the oven. The scanner unit 42 was arranged to scan the laser beam in a transverse direction: i.e. perpendicular to the direction of travel of the web through the oven. The arrangement allowed for beam control, scanning and focusing of the beam onto the moving web. The beam expander 44 was adjusted to provide a spot size of 0.3-0.4 mm diameter on the surface of the web. Other features of the apparatus were as follows:
Laser: Rofin SC x30 CO₂ laser
Wavelength: 10.6 μm
Power: 10-300 W (attenuated to ˜80% of the output power at the workpiece)
Pulse length: 5-400 μs
Peak power: 220-750 W
Repeat rate: 0-62.5 kHz
Scanner: GSI Lumonics

The image definition was controlled by changing the laser repetition rate, pulse width, scanned width and laser spot size. These parameters were found to change the image size and opacity with variations in laser pulse overlap and pulse power density adjusted to optimize the marking process.

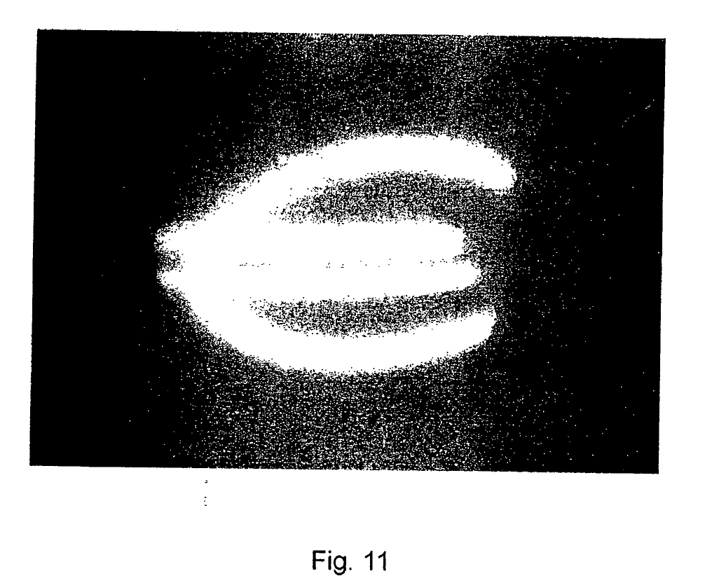

The laser was used to produce patterned “watermarks” in the shape of the Euro symbol [symbol] , with a maximum repetition rate of 62.5 kHz and minimum pulse length of 5 μsec. These were the typical conditions used, with the “watermarking” quality determined by viewing the web opacity using a light source behind the moving web on the production line. An example of a laser watermark seen by transmitted light is shown in FIG. 11.

Although the exact mechanism of the process that creates watermarks is not entirely certain at present, we believe that the slight increase in the temperature of the web surface produced by the incident radiation increases the elasticity of the web, allowing the irradiated portions to stretch more readily than the remainder of the web. This produces a slight decrease in the thickness and the amount of material in the irradiated regions of the sheet, resulting in an increased translucency. The increased elasticity also appears to cause reduced voiding in the irradiated portions of the sheet, which contributes to the increased translucency of the sheet in the affected regions.

The exact point of irradiation is not critical and may be slightly ahead of or behind the point where stretching commences, providing that it is not so far ahead that any heating of the surface of the web produced by the incident radiation has been dissipated prior to the commencement of the stretching, or so far behind that the stretching operation has already been substantially completed. Ideally, the irradiation point should be as close as possible to the start of the stretching operation.

The laser may be continuous or pulsed and scanning apparatus may be provided to move the point at which the radiation strikes the web, in the transverse and/or longitudinal directions. Pulsing and/or scanning of the laser may be controlled, for example by a computer, to create watermarks containing images, logos or text or variable data. Different light sources may be used, providing they are sufficiently powerful to heat the surface of the web reasonably quickly and can be focused onto a sufficiently small spot to provide good definition. The radiation may be of visible or infrared wavelengths.

The web may be stretched biaxially or in only one direction. In the case of biaxial stretching, this is preferably simultaneous, although sequential stretching operations are also possible. In this latter case, the web may be irradiated before either or both of the separate stretching operations.

What is claimed is:

1. A watermarked polymeric sheet, comprising a stretched sheet of a polymeric material having a plurality of indentations in at least one surface thereof, the indentations comprising areas of increased translucency, which form a watermark that is visible by transmitted light.

2. A sheet according to claim 1, in which the weight per unit area of the polymeric sheet is reduced in the indentations.

3. A sheet according to claim 1, in which the indentations have an average depth in the range 4-100 μm.

4. A sheet according to claim 3, in which the indentations have an average depth in the range 10-40 μm.

5. A sheet according to claim 1, in which the polymeric material includes at least one polyolefin.

6. A sheet according to claim 5, in which the polymeric material comprises polyethylene.

7. A sheet according to claim 1, in which the stretched sheet comprises a plurality of voids.

8. A sheet according to claim 7, in which the polymeric material comprises a voiding agent.

9. A sheet according to claim 7, in which the number of voids is reduced in the indentations.

10. A sheet according to claim 1, in which stretched sheet has multiple co-extruded layers, including a base layer and at least one co-extruded outer layer.

11. A sheet according to claim 10, in which the base layer comprises a plurality of voids and said at least one co-extruded outer layer comprises substantially no voids.

12. A sheet according to claim 1, in which the sheet is biaxially oriented.

13. A sheet according to claim 1, in which the polymeric sheet is a synthetic paper.

14. A sheet according to claim 1, in which the surface of the polymeric sheet comprises a coating and/or is treated chemically and/or by corona discharge.

15. A sheet according to claim 1, wherein the polymeric material comprises a copolymer of HDPE, a rosin derived voiding agent, polystyrene, HDPE homopolymer, calcium carbonate filler, titanium dioxide, styrene butadiene and calcium oxide.
